(19) United States
(12) Patent Application Publication
(10) Pub. No.: US 2003/0067664 A1
(43) Pub. Date: Apr. 10, 2003

(54) Optical unit for an optical scanning device

(76) Inventors: Aik Seng Yak, Singapore (SG); Ramasubramanian Natarajan, Singapore (SG)

Correspondence Address: U.S. Philips Corporation, 580 White Plains Road, Tarrytown, NY, 10591, US

(21) Appl. No.: 10/245,464

(22) Filed: Sep. 17, 2002

(30) Foreign Application Priority Data
Sep. 20, 2001 (WO) SG01/00193

(51) Int. Cl. G02B 26/08

(52) U.S. Cl. 359/205

(57) ABSTRACT

An optical unit (10) for an optical scanning device includes a one-piece component (18) having a built-in beam splitter (14) and built-in portions configured to house a radiation source (20) and a radiation-sensitive detector (22). The optical unit has a good radiation efficiency and is small and light-weight. The one-piece component may be made of glass or a transparent plastic material and may also comprise a diffraction grating (16) and an objective lens (12).

The invention relates to an optical unit for an optical scanning device comprising a radiation source for supplying a scanning beam, an objective lens for focusing the scanning beam to a scanning spot on an object that is to be scanned and a radiation-sensitive detector for converting a reflected beam, reflected by the scanned object, into electric signals.

The invention also relates to an optical scanning device comprising such an optical unit.

The optical scanning device is typically, but not exclusively, used to scan an information layer of an optical record carrier, for example an optical disc such as a compact disc (CD) or a digital versatile disc (DVD). In that case, scanning of the object is understood to mean scanning of the information layer for the purpose of both reading the information of a recorded information layer and writing information in a blank or partially blank information layer.

Currently available technology provides optical scanning devices, the most compact of which use a holographic optical element. This element deflects the reflected beam from the path of the ongoing beam and towards the detection system. The holographic optical element may be a grating having a linearly varying grating period, which renders the reflected beam passing through it astigmatic. With such an astigmatic beam, together with a four-quadrant detector, a focus error signal can be generated, as described in U.S. Pat. No. 4,358,200.

However, use of a hologram in an optical scanning device renders this device quite inefficient with respect to the radiation intensity. Only 6% of the radiation emitted by the source reach the detection system in such a device. This makes an optical unit with a holographic optical element unsuitable for use in a scanning device which needs to read from an object with low reflectance, such as a recordable compact disc (CD-R) or a rewritable compact disc (CD-RW). The unit with a holographic optical element is also expensive to produce and any design changes on it are hard to implement.

In spite of the recognized need, a continuing failure in the art has been an inability to increase the efficiency of the optical power of compact optical scanning devices, while at the same time lowering production costs. Consequently, there has been a continuing inability to provide a compact optical pick-up unit that is both low-cost and radiation efficient.

It is an object of the present invention to alleviate these drawbacks and provide an optical unit for an optical scanning device, which unit is compact, low-cost and radiation efficient. This unit is characterized in that it comprises a one-piece component for accommodating the radiation source, the detector and has a built-in skew portion forming a beam splitter.

The invention is based on the insight that by replacing the holographic optical element by a simple beam splitter, not only the radiation efficiency can be increased but it becomes also possible to manufacture a one-piece component having an internal wall functioning as the beam splitter. By such an integration, the optical scanning device becomes more compact and can be manufactured at lower cost.

It is noted that U.S. Pat. No. 4,358,200 also disclose an optical scanning device that comprises a beam splitter for separating the reflected beam from the beam going to the record carrier and for directing the reflected beam towards the detector. In this scanning device, all optical components are stand-alone components and the beam splitter does not form part of a one-piece component which also accommodates the radiation source and the detector.

The optical unit is preferably characterized in that the beam splitter is configured as a plate so as to introduce astigmatism in the reflected beam.

As the reflected beam incident on the beam splitter, shaped as a plate having a certain thickness, is a convergent beam, this plate makes the beam sufficiently astigmatic so that the beam can be used to generate a focus error signal in accordance with the astigmatic method. This method is described in U.S. Pat. No. 4,358,200 with reference to a scanning device with stand-alone optical components.

With respect to the radiation source, the optical unit is further characterized in that the one-piece component comprises a first wall arranged at a first side of the beam splitter and configured to house the radiation source.

With respect to the detector, the optical unit is further characterized in that the one-piece component comprises a second wall arranged at a second side of the beam splitter and configured to house the radiation-sensitive detector.

The optical unit may be further characterized in that a built-in diffraction grating is arranged between the radiation source and the beam splitter.

Such a grating, known as three-spot grating, splits the beam from the radiation source in a main beam, and two auxiliary beams. The main beam is focused to a main, scanning, spot m in the information layer of an optical record carrier and the auxiliary beams are focused to auxiliary spots, each at a different side of the main spot. The auxiliary spots are used to keep the main spot on track as is well known in the art.

The objective lens of the optical scanning device may be arranged outside the one-piece component. Preferably, the optical unit is characterized in that the objective lens is built in the one-piece component.

By this measure, the optical unit becomes even more compact.

The built-in objective lens may be a discrete lens, which is positioned in the one-piece component after the latter has been manufactured. Preferably, the optical unit is characterized in that the objective lens is made of the same material as the one-piece component.

This allows the objective lens to be manufactured together with the one-piece component, so that the optical unit can be manufactured at even lower cost.

According to a further aspect of the invention, the optical unit is characterized in that the one-piece component is made of glass.

Especially for the beam splitter and the integrated objective lens, glass has an excellent optical quality.

Alternatively and preferably, the optical unit is characterized in that the one-piece component is made of a transparent plastic material.

The use of a transparent plastic allows reduction of the mass of the one-piece component and thus of the scanning device, which is important for a fast access scanning device. A suitable transparent plastic is polymethyl methacrylate (PMMA) or polycarbonate (PC), which are currently used in the optical field and have a sufficient optical quality.

The invention also relates to an optical scanning device for scanning an object and comprising an optical unit for supplying a scanning beam and detector signals generated by a scanning action, means for moving the optical unit and the object relative to each other and electronic processing means for processing the detector signals to an information signal containing information about the object being scanned. This scanning device is characterized in that the optical unit is a unit as described above.

The beneficial effects described above generally apply to the exemplary devices, mechanisms and method steps disclosed herein with regard to optical units for optical scanning devices and for miniaturized optical scanning devices. The specific structures and steps through which these benefits are delivered will be described in greater detail below.

In the drawings:

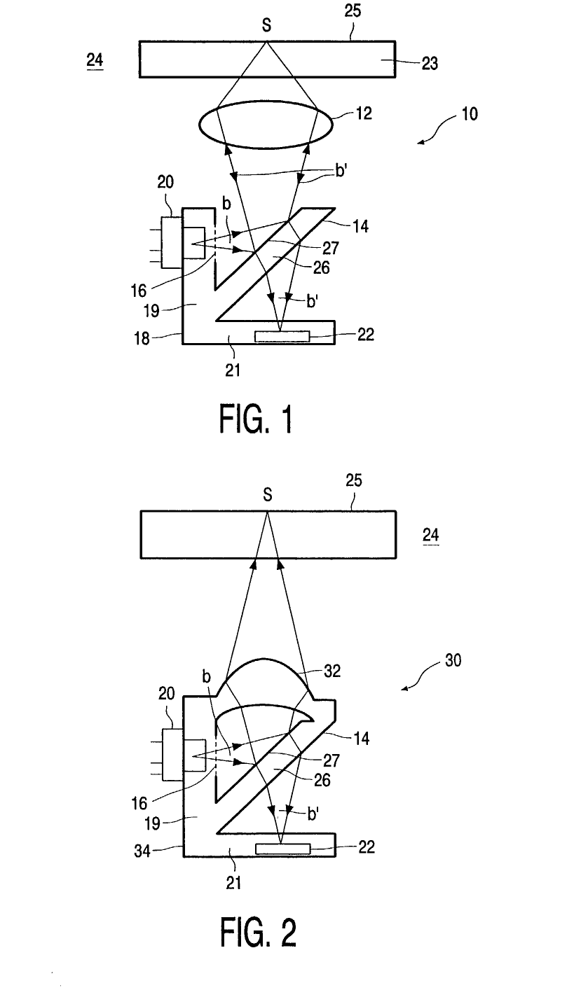

FIG. 1 illustrates a first embodiment of an optical unit according to the invention, having a separate objective lens; and

FIG. 2 illustrates a second embodiment of an optical unit according to the invention, having a built-in objective lens.

As required, detailed embodiments of the present invention are disclosed herein; however, it is to be understood that the disclosed embodiments are merely examples of the invention that may be embodied in various and alternative forms. The Figures are not necessarily drawn to scale, some features may be exaggerated or minimized to show details of particular components. Therefore, specific structural and functional details disclosed herein are not to be interpreted as limiting, but merely as a basis for the claims and as a representative basis for teaching those skilled in the art to employ the present invention in various ways.

FIG. 1 illustrates an embodiment of an optical unit according to the present invention having a separate objective lens. This optical unit may form part of an optical scanning device for scanning the information layer 25 of an optical disc 24. In general, an optical scanning device comprises a radiation source 20, for example a laser, preferably a semiconductor laser, or a light-emitting diode (LED). Another key component of the scanning device is the objective lens 12, which focuses the beam b emitted by the source 20 to a scanning spot S in the information layer 25 of the optical disc 24, which has a transparent substrate 23. The scanning device further comprises a composed radiation-sensitive detector 22, which converts the reflected beam b′ reflected by the information plane into electric signals. From these signals, a read signal, a focus-error signal and a track-error signal can be derived, as is well known in the art.

To deflect the reflected beam b′ out of the path of the ongoing beam b and towards the detector 22, a holographic optical element is used in a conventional compact scanning device. This element may be a diffraction grating composed of two sub-gratings having different grating periods or differently oriented grating strips. One of the beams diffracted by the grating in different diffraction orders, preferably a first-order beam is directed to the detector. Due to the presence of the two sub-gratings, this first-order beam is split in two spatially separated sub-beams. These sub-beams are used to generate a focus error signal in a way well known in the art. In this scanning device, only a minor portion, for example of the order of 6%, of the radiation emitted by the source reaches the detector in practice.

To increase this portion and to decrease the volume and mass of the scanning device, the holographic optical element is replaced by a beam splitter 14 and this beam splitter is accommodated in a one-piece component 18, as shown in FIG. 1. This component comprises a first outer wall 19 having an opening wherein the radiation source 20 is positioned and a second outer wall 21 having an opening to accommodate the detector 22. The component further comprises a skew internal wall 26, one side of which faces the radiation source 22 and the other side the detector 20. The material of the one-piece component 18 is transparent, which allows using the skew wall as a carrier for a coating, which reflects part of the intensity of an incident radiation beam and transmits the rest of this intensity. By coating the skew wall 26 with such a coating 27, a low-cost beam splitter 14 is obtained, which requires no additional space. This beam splitter 14 reflects part of the beam b from the source to the optical disc and transmits part of the reflected beam b′ to the detector. As is well known in the art, the coating 27 includes a stack of λ/4 and λ/2 layers, λ being the wavelength of the beams b and b′. The composition of the coating determines its transmission and reflection, thus the portion of beam b that is reflected towards the disc and the portion of the beam b′ that is transmitted towards the detector. The composition of the coating can be adapted to the envisaged application of the scanning device. If an optical disc having a good reflection, such as a CD is to be read, the reflection and transmission may be both 50%. Then 50% of the source radiation will reach the information layer 25 of the disc and 25% of the source radiation will reach the detector 20. If an optical disc having a lower reflection is to be read, or if information is to be written in an information layer, the coating may have such a composition that more than 50% of the source radiation is reflected to the disc. The percentages given above are theoretical ones. In practice the percentages are lower due to radiation losses caused by unwanted reflections, inter alia, at the non coated side of the beam splitter, at the front side of the disc and at the entrance surface of the detector and especially due to radiation losses in the disc. When two scanning devices, which differ from each other only in that the first one comprises a beam splitter according to the invention whilst the second one comprises a Foucault grating, are compared in practice, it turns out that, in the first device, the amount of radiation incident on the detector is of the order of 12,5% whilst this amount is of the order of 6% in the second device. The radiation efficiency of the optical unit of the invention is substantially greater than that of the conventional unit.

The one-piece component 18 may be made of any suitable rigid, transparent material, such as glass or a transparent plastic material like polymethyl methacrylate (PMMA) or polycarbonate (PC). Glass has the advantage that it is not sensitive to changes in environmental parameters like temperature or humidity. The transparent plastics have a smaller weight than glass so that the mass of the optical unit can be reduced by using these plastics.

The beam splitter 14 should have a certain thickness to give it sufficient rigidity. This thickness and the fact that the reflected beam b′ is not a parallel beam, but a convergent beam allows use of the beam splitter as an a-stigmatizing component which introduces astigmatism in the beam going to the detector. Provided that detector 22 comprises a four-quadrant detector, the astigmatic method can be used to generate a focus error signal, as described in U.S. Pat. No. 4,358,200.

As shown in FIG. 1, the design of the one-piece component 18 further allows accommodation of a three-spot diffraction grating 16 at the inner side of the wall 19, such that it faces the radiation source 20. As is known in the art, such a grating allows formation of two auxiliary, or follow-on, spots, each at a different side of the main spot in the information layer of the record carrier. If the follow-on spots are imaged by the objective lens 12 on different detector elements of the detector 22, the output signals of these detector elements can be processed to a tracking error signal. The grating 16 at the inner side of the wall 21 of the one-piece component 18 can be produced simultaneously with this component, for example by means of a moulding process. Thus a low-cost three-spot grating, which does not require additional space can be added to the optical unit.

The stand-alone objective lens 12 in the optical unit of FIG. 1 can be replaced by an objective lens, which forms part of the one-piece component 18. The latter objective lens and the component 18 may be produced separately and the objective lens may then be fixed to the upper side of the component 18, for example, it may be sunk in orifices reserved for this lens in the component 18.

FIG. 2 shows an embodiment of an optical unit 30 according to the invention wherein a further integration of components has been carried out. The one-piece component 34 is now provided with an upper side of the same material as the rest of the material, which upper side 32 is shaped in such a way that it focuses the beam b in the same way as the objective lens in FIG. 1 so that it replaces the latter lens. In this way, a low-cost objective lens 32, which does not require additional space, is obtained.

The objective lens 12 in the embodiment of FIG. 1 and the objective lens 32 in the embodiment of FIG. 2 may be a mono-aspheric or a bi-aspheric lens. A mono-aspheric lens has one aspheric surface and a bi-aspheric lens has two aspheric surfaces. An aspheric surface is understood to mean a refractive surface, whose basic shape is spherical or flat, but whose actual shape shows small deviations from the basic shape in order to compensate for spherical aberrations.

In optical scanning units it is common practice to move the objective lens relative to the information layer for correcting focus and tracking errors. In conventional devices, the objective lens then also moves with respect to a holder accommodating the radiation source, the detector and a beam splitter or grating. In the FIG. 2 embodiment of the optical unit, wherein the objective lens is fixed to the one-piece component 18, a movement of the objective lens is realized by moving the whole optical unit. The working distance of the objective lens, i.e. the distance between the lens surface facing the disc and the disc entrance surface may be reduced to 12 mm, instead of the more current distance of 3 to 4 mm. By designing the objective lens in such a way that it has a small conjugate, i.e. a small distance between the object plane and the object side main plane of the lens, the size, and thus the mass, of the optical unit can be further reduced.

In summary, the characterizations and data comprised herein demonstrate the utility and success of the advantageous integration of various components of an optical scanning device according to the invention into the optical unit 10, 30, comprising a single component of transparent plastic, such as PMMA, or glass that can be advantageously used to replace at least three functions handled by the separate components in currently available optical scanning devices. For example, the laser guiding unit 10, 30 of the present invention can be advantageously used to replace the separately made and installed diffraction grating, beam splitter and optical housing of a currently used optical scanning unit.

Furthermore, the optical unit 10, 30 of the present invention is compact and lightweight and has the opportunity of achieving a very low cost per piece in mass production. Moreover, the optical unit 10, 30 allows manufacture of a low-cost, light-efficient, compact and highly integrated optical scanning device, so that such a scanning device represents an implementation of the invention. In addition to the optical unit for supplying a scanning spot and detector signals generated by a scanning action, such a scanning device comprises means for moving the optical unit and the object relative to each other and electronic processing means for processing the detector signals to an information signal containing information on the object being scanned.

As described above, such an optical scanning device may be used for reading optical discs, such as compact discs (CDs), recordable compact discs (CD-Rs), rewritable compact discs (CD-RWs) and digital versatile discs (DVDs). The optical scanning device of the invention can also be applied to general optical scanning purposes, such as in a scanning optical microscope and in a surface inspection or surface roughness measurement apparatus.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

1. An optical unit for an optical scanning device comprising a radiation source for supplying a scanning beam, an objective lens for focusing the scanning beam to a scanning spot on an object that is to be scanned, and a radiation-sensitive detector for converting a reflected beam, reflected by the scanned object, into electric signals, characterized in that the unit comprises a one-piece component for accommodating the radiation source, the detector and has a built-in skew portion forming a beam splitter.

2. An optical unit as claimed in claim 1, characterized in that the beam splitter is configured as a plate so as to introduce astigmatism in the reflected beam.

3. An optical unit as claimed in claim 1 or 2, characterized in that the one-piece component comprises a first wall arranged at a first side of the beam splitter and configured to house the radiation source.

4. An optical unit as claimed in claim 1,2 or 3, characterized in that the one-piece component comprises a second wall arranged at a second side of the beam splitter and configured to house the radiation-sensitive detector.

5. An optical unit as claimed in claim 1, 2, 3 or 4, characterized in that a built-in diffraction grating is arranged between the radiation source and the beam splitter

6. An optical unit as claimed in anyone of claims 1 to 5, characterized in that the objective lens is built in the one-piece component.

7. An optical unit as claimed in anyone of claims 1 to 6, characterized in that the one-piece component is made of glass.

8. An optical unit as claimed in anyone of claims 1 to 7, characterized in that the one-piece component is made of a transparent plastic material.

9. An optical scanning device for scanning an object and comprising an optical unit for supplying a scanning beam and detector signals generated by a scanning action, means for moving the optical unit and the object relative to each other and electronic processing means for processing the detector signals to an information signal containing information about the object being scanned, characterized in that the optical unit is a unit according to any one of claims 1 to 8.
